(19) United States
(12) Patent Application Publication
(10) Pub. No.: US 2001/0056471 A1
(43) Pub. Date: Dec. 27, 2001

(54) User interface system, scene description generating device and method, scene description distributing method, server device, remote terminal device, recording medium, and sending medium

(76) Inventors: Shinji Negishi, Kanagawa (JP); Hideki Koyanagi, Kanagawa (JP); Yoichi Yagasaki, Tokyo (JP)

Correspondence Address: SONNENSCHEIN NATH & ROSENTHAL, P.O. BOX 061080, WACKER DRIVE STATION, CHICAGO, IL, 60606-1080, US

(21) Appl. No.: 09/795,842

(22) Filed: Feb. 28, 2001

(30) Foreign Application Priority Data
Feb. 29, 2000 (JP) P2000-055055

(51) Int. Cl. G06F 15/16

(52) U.S. Cl. 709/208; 709/203

(57) ABSTRACT

A user interface system comprises a server having a scene description decoding device for decoding input scene description and an equipment control signal generating device for generating equipment control signals, a remote terminal having a scene description decoding device for decoding scene description sent form the server into decoded scenes and a display device for displaying the decoded scenes and a user input device for receiving user input according to this display, a display terminal for displaying decoded scenes from the server, and controlled equipment which is controlled by equipment control signals from the server. Thus, easy operation of the remote terminal is facilitated.

### BACKGROUND OF THE INVENTION

1. Field of the Invention

The present invention relates to a user interface system which uses scene description information containing user interaction, a scene description generating device and method, a scene description distributing method, a server device, a remote terminal device, and a sending medium and recording medium.

2. Description of the Related Art

FIG. 7 shows a conventional user interface system wherein menu data is transmitted from a server to a remote terminal in order to control multiple pieces of controlled equipment with a single remote terminal, at the time of performing equipment control with a remote terminal.

A server 701 sends menu data 723 stored in a menu data storing device 703 to a remote terminal 706 via a transmitting/receiving device 705. The server 701 is a TV or home server, for example. The remote terminal 706 displays the received menu data 723 on a display device 707. A user input device 708 converts user input 709 into user input information 710 such as which menu has been selected for example, and sends this to the server 701 via a transmitting/receiving device 705b. Exchange of the menu data 723 and user input information 710 is generally performed by infrared rays or the like. An equipment operating signal generating device 704 within the server 701 converts the user input information 710 into equipment control signals 714 for the controlled equipment 715 corresponding to the menu, thereby controlling the controlled equipment 715.

An example of such a user interface system is shown in FIG. 8. The server 801 transmits menu data 823 to the remote terminal 806. In the example in FIG. 8, the menu data 823 comprises a stop and record menu for controlling a VCR. The remote terminal 806 displays the menu data 823. In the example in FIG. 8, the menu data 823 is displayed using a touch panel. In the event that the user selects the record menu for example, the remote terminal 806 transmits user input information 810 to the effect that record has been selected, to the server 801. The server 801 generates equipment control signals 814 for recording with the controlled equipment 815, and sends the signals to the controlled equipment 815, thereby starting recording by the VCR in the example shown in FIG. 8.

The menu data 823 for the remote terminal 806 is of a data format dependent on the display device of the remote terminal 806, and accordingly there is the problem that there is no compatibility between different remote terminals 806.

Now, there are contents described with scene description methods capable of containing interaction by user input, such as digital TV broadcasts and DVD, Internet home pages described with HyperText Markup Language (hereafter referred to as “HTML”) or the like, Binary Format for the Scene (hereafter referred to as “MPEG-4 BIFS”) which is a scene description format stipulated in ISO/IEC14496-1, Virtual Reality Modeling Language (hereafter referred to as “VRML”) which is stipulated in ISO/IEC14472, and so forth. The data of such contents will hereafter be referred to as “scene description”. Scene description also includes the data of audio, images, computer graphics, etc., used within the contents.

FIG. 9 shows an example of scene description containing interaction. In the example in FIG. 9, buttons for selecting a “sphere”, “rectangle”, and “triangle”, are contained in the input scene description 900 beforehand. The decoded scene 912 which has been decoded by the server 901 is displayed on the display terminal 913. The server 901 normally displays a user selection position display 924 on the display terminal 913, in order to supplement the input by the user. The user operates the remote terminal 906 while watching the decoded scene 912 and user selection position display 924 displayed on the display terminal 913. The remote terminal 906 is a keyboard or mouse of the like. The user input information 910 is transmitted from the remote terminal 906 to the server 901. User input is the amount of movement of the user selection position, for example. The server 901 decodes the scene description input 900, based on the user input. In the example in FIG. 9, in the event that the user selects the “rectangle” button for example, a rectangle is displayed.

The coding at the time of viewing and listing to contents of scene description containing user input interaction such as with the example in FIG. 9, and the user interaction system, are shown in FIG. 10.

The remote terminal A06 receives user input A09, and transmits the user input information A10 such as change in user selection position for example, to the server A01 via the transmitting device A05b. The scene description decoding device A02 of the server A01 decodes the scene description input A00 based on the received user input information A10. The decoded scene A12 which has been decoded is displayed on the display terminal A13.

As shown in FIGS. 9 and 10, in the event of viewing or listening to contents made up of scenes containing user input interaction, the user must operate the remote terminal while watching the display terminal. In the case of using a remote terminal such as a keyboard in particular, a certain level of skill is require for operating the remote terminal while viewing the display terminal, and in many cases, the user must perform input while alternately checking the display terminal and the remote terminal. Further, this movement of the view of the user tends to cause the user to make errors in the input.

The user interface for controlling the controlled equipment shown in FIGS. 7 and 8, and the user interface for interaction contained in the scene description itself shown in FIGS. 9 and 10, are handled separately.

As described above with reference to the conventional art, at the time of performing equipment control from a remote terminal, the menu data for the remote terminal is of a data format dependent on the display device of the remote terminal, in the case of a user interface system which transmits menu data from a server to a remote terminal. According, there is the problem that there is no computability of menu data between different remote terminals.

Also, the menu data is stored in the server or remote terminal at the time of manufacturing the server or remote terminal, so updating or adding controlled equipment has been difficult. Updating the menu data necessitates that menu data of a data format dependent on the display device of the remote terminal be generated with a dedicated generating device, and there has been the need to make input to the server or the remote terminal via a recording media or sending media which can handle a dedicated data format.

Also, as described with the conventional art, in order to view or listen to contents of scenes containing user input interaction such as digital TV broadcasts and DVD, Internet homepages, MPEG-4 BIFS, VRML, etc., the user must operate the remote terminal while watching the display device of the display terminal. Particularly, in the event of using a remote terminal such as a keyboard, a certain level of skill is require for operating the remote terminal while viewing the display terminal, and in many cases, the user must perform input while alternately checking the display terminal and the remote terminal. Further, this movement of the view of the user tends to cause the user to make errors in the input. There is strong demand for an arrangement wherein user input can be easily made by anyone without special training, but this could not be achieved by the conventional art.

The user interface for controlling the controller equipment and the user interface for interaction contained in the scene description itself are handled separately, so there has been the need to have individual remote terminals for each.

### SUMMARY OF THE INVENTION

Accordingly, it is an object of the present invention to solve the above problems, and to provide a user interface system, a scene description generating device and method, a scene description distributing method, a server device, a remote terminal device, and a sending medium and recording medium, which enable user input while watching only the remote terminal with regard to scenes containing user input interaction, and further enable the user interface for controlling the controlled equipment and the user interface for interaction contained in the scene description itself to be handled integrally.

To this end, according to a first aspect of the present invention, a user interface system using scene description information containing user interaction comprises: a server; and a remote terminal comprising decoding means for decoding scene description information, display means for displaying scenes, and input means for inputting user input information; wherein the server sends scene description information to the remote terminal, the remote terminal decodes scene description information sent from the server with the decoding means thereof and displays on the display means, and user input information input to the input means according to the display is sent to the server.

According to a second aspect of the invention, a scene description generating device for generating scene description information containing user interaction comprises generating means generating control scene description information for controlling external controlled equipment, with the same scene description method as that of the contents.

According to a third aspect of the invention, a scene description generating method for generating scene description information containing user interaction comprises a generating step for generating control scene description information for controlling external controlled equipment, with the same scene description method as that of the contents.

According to a fourth aspect of the invention, a scene description distribution method uses scene description information containing user interaction to distribute scene description information to a system comprising a server and remote terminal; wherein scene description information of the device control menu generated by the same scene description method as that of the contents is distributed, and scene description information stored in the server or the remote terminal is updated with the scene description information.

According to a fifth aspect of the invention, a server device uses scene description information containing user interaction and cooperatively with a remote terminal configures a user interface, wherein scene description information is sent to the remote terminal, and user input information input according to the scene description information which has been decoded and display at the remote terminal is received.

According to a sixth aspect of the invention, a remote terminal device which uses scene description information containing user interaction and cooperatively with a server configures a user interface comprises: decoding means for decoding scene description information; display means for displaying scenes; and input means for inputting user input information; wherein scene description information sent from the server is decoded and displayed on the display means, and user input information input to the input means according to the display is sent to the server.

According to a seventh aspect of the invention, the scene description information describing the equipment control menu is described with the same scene description method as that of the contents regarding a sending medium for sending scene description information containing user interaction.

According to an eighth aspect of the invention, the scene description information describing the equipment control menu is recorded with the same scene describing method as that of the contents, with regard to a recording medium for recording scene description information containing user interaction.

That is to say, the present invention is a user interface system wherein the remote terminal comprises a scene description decoding device capable of decoding the same scene description as the server, and a display device, so that scene description is transmitted to and displayed on the remote terminal, and user input that has been input at the remote terminal is transmitted to the server.

The remote terminal decoding and displaying the scene description input means that the user can perform user input for scenes containing interaction by user input while watching only the remote terminal.

Also, using scene description for the equipment control menu data so as to be decoded by the same scene description decoding device allows the user interface for equipment control and the user interface interaction contained in the scene description itself to be handled integrally. Further, the contents containing interaction and scene description representing the equipment control menu can be generated with the same scene description generating device, thereby enabling recording to the same recording medium and sending with the same sending medium, consequently enabling updating of the equipment control menu to be performed using a recording medium or sending medium for scene description of contents containing interaction.

### BRIEF DESCRIPTION OF THE DRAWINGS

FIG. 1 is a block diagram representing the configuration of a user interface system corresponding to a first embodiment;

FIG. 2 is a diagram representing an example of a user interface system corresponding to a first embodiment;

FIG. 3 is a block diagram representing the configuration of a user interface system corresponding to a second embodiment;

FIG. 4 is a block diagram representing the configuration of a user interface system corresponding to a third embodiment;

FIG. 5 is a block diagram representing the configuration of a scene description generating device corresponding to the fourth embodiment and scene description sending thereof;

FIG. 6 is a diagram representing an example of scene description corresponding to the fourth embodiment;

FIG. 7 is a block diagram representing the configuration of a conventional user interface system for equipment control;

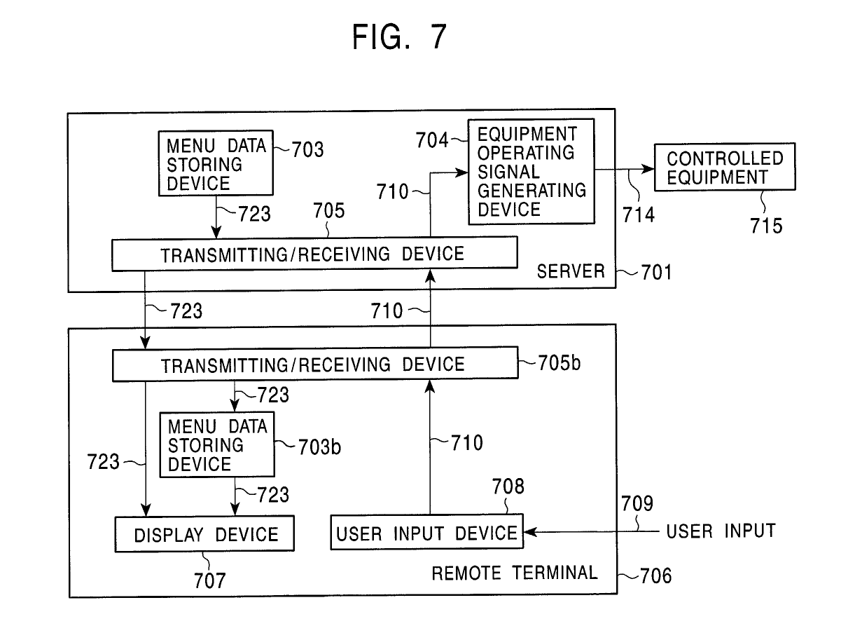

FIG. 8 is a diagram representing an example of a conventional user interface system for equipment control;

FIG. 9 is a diagram representing an example of conventional scene description containing interaction and a user interface system; and

FIG. 10 is a block diagram representing the configuration of a user interface system regarding scene description containing interaction according to the conventional art.

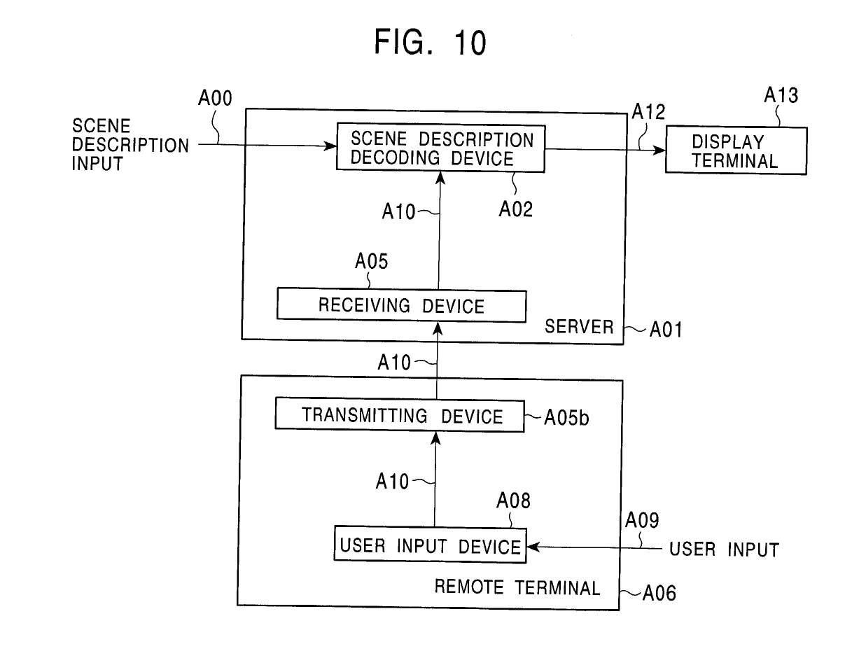

### DESCRIPTION OF THE PREFERRED EMBODIMENTS

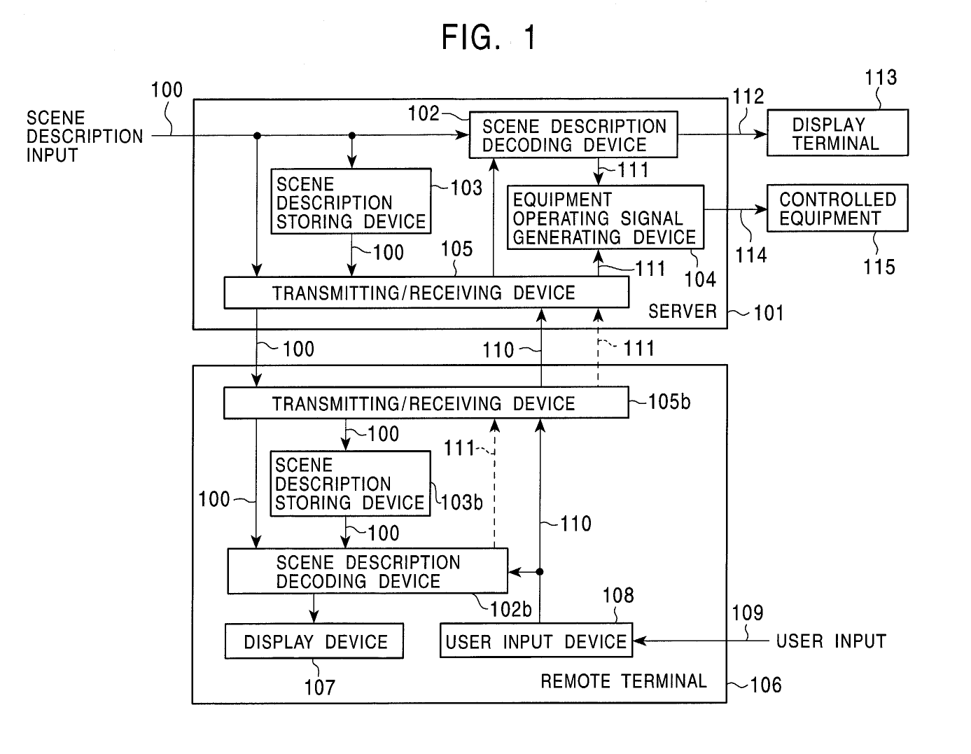

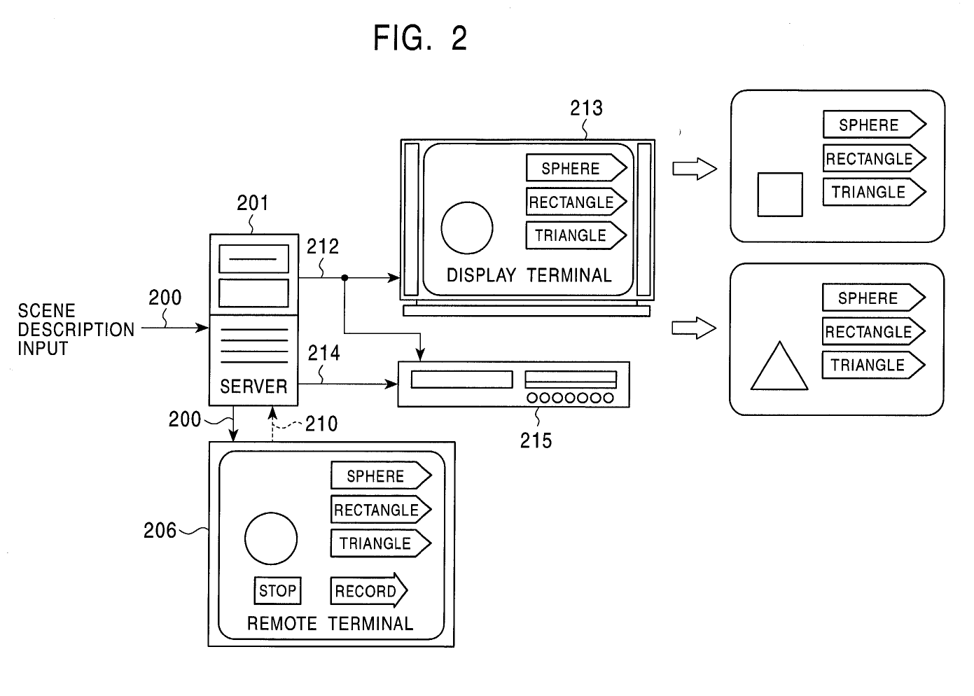

First, description will be made regarding the user interface system as a first embodiment of the present invention, with reference to FIGS. 1 and 2.

The user interface system shown in FIG. 1 comprises a server 101 into which scene description 100, i.e., scene description information is input, a remote terminal 106 which displays the scene description 100 sent from the server 101 and receives user input 109 according to this display, a display terminal 113 for displaying decoded scenes 112 sent from the server 101, and controlled equipment 115 which is controlled by equipment controlling signals 114 sent from the server 101.

The server 101 has a scene description decoding device 102 for decoding decoded scenes 112 based on input scene description 100 and user input information 110, and generating equipment control information 111, a scene description storing device 103 for storing input scene description 100, and equipment operating signal generating device 104 for generating equipment control signals 114 based on the equipment control information 111, and a transmitting/receiving device 105 for sending scene description 100 stored in the scene description storing device 103 to the remote terminal 106 and also receiving user input information 110 and equipment control information 111 from the remote terminal 106 and sending user input information 110 to the scene description decoding device 102 and equipment operating signal generating device 104 and also equipment control information 111 to the equipment operating signal generating device 104.

The remote terminal 106 has a display device 107 for displaying decoded scenes 112, a user input device 108 for receiving user input 109 according to this display, a scene description decoding device 102b for decoding scene description 100 into decoded scenes 112 based on the user input information 110 from the user input device 108 and generating equipment control information 111, a scene description storing device 103b for storing scene description 100 and sending it to the scene description decoding device 102b, and a transmitting/receiving device 105b for receiving scene description 100 sent from the server 101 and sending it to the scene description decoding device 102b and scene description storing device 103b and also receiving equipment control information 111 from the scene description decoding device 102b and user input information 110 from the user input device 108 and sending this to the server 101.

The server 101 in the first embodiment is a receiver terminal for digital TV broadcasting, a DVD player, a personal computer, a home server, or the like. The scene description decoding device 102 within the server 101 decodes scene description input 100 containing interaction such as DVD contents and HTML to decoded scenes 112, and displays this on the display terminal 113. The display terminal 113 is a TV or personal computer monitor or the like, and may be integral with the server 101.

The server 101 according to the first embodiment has a scene description storing device 103, and the menu data for equipment controlling is stored in the scene description storing device 103. Here, the equipment control menu data is characterized in being scene description data which can be decoded by a scene description decoding device in the same manner as contents containing interaction. The scene description for the equipment control menu data is transmitted from the server 101 to the remote terminal via the transmitting/receiving device 105. The remote terminal 106 according to the present invention is characterized in having a scene description decoding device 102b the same as that for decoding contents containing interaction.

In the event of performing equipment control, the scene description decoding device 102b of the remote terminal 106 decodes scene description input either transmitted from the server 101 or read out from the scene description storing device 103b inside the remote terminal 106, representing menu data for equipment control, and this is displayed by the display device 107. The user performs input for equipment control while watching the menu screen for equipment control obtained by decoding the scene description. The user input device 108 sends the user input 109 to the scene description decoding device 102b as user input information 110. User input information 110 is information such as the selected position of the user and so forth. The scene description decoding device 102b decodes the scene description input based on the user input information 110, thereby enabling display of a menu according to the selection of the user. On the other hand, the remote terminal 106 transmits the user input information 110 to the server 101 via the transmitting/receiving device 105b. The server 101 converts the user input information 110 into device control signals 114 with the equipment operating signal generating device 104, and transmits this to the controlled equipment 115 by a transmitting device not shown in the drawings. In the event that the correlated relation of the equipment control information 111 according to the user input information 110 is described in the scene description, the user input information 110 is mapped to the equipment control information 111 by the scene description decoding device 102 or 102b and then sent to the equipment control signal generating device 104. There are cases wherein the controlled equipment 115 is the server 101 itself.

In the event of viewing or listening to contents of scenes containing user input interaction such as digital TV broadcasts and DVD, Internet homepages, MPEG-4 BIFS, VRML, etc., the scene description 100 input to the server 101 is decoded by the scene description decoding device 102 and displayed, and also is transmitted to the remote terminal 106 via the transmitting/receiving device 105. The remote terminal 106 according to the present embodiment comprises a scene description decoding device 102b the same as that for decoding contents containing interaction, so the scene description input 101 can be displayed by the display device 107 in the remote terminal. Accordingly, the user can perform user input while watching only the remote terminal 106 and never seeing the display terminal 113, thus providing a solution to the problem of the conventional art wherein the user had to alternately check the display terminal 113 and the remote terminal 106 to perform input.

Also, the scene description 100 representing the equipment control menu data to be stored in the scene description storing devices 103 and 103b may be input by a recording medium or sending medium for scene description of contents containing interaction, and updated by the scene description storing devices 103 and 103b. This can be realized due to the characteristics of the present invention wherein the equipment control menu data is scene description data which can be decoded by a scene description decoding devices in the same manner as that for the contents containing interaction.

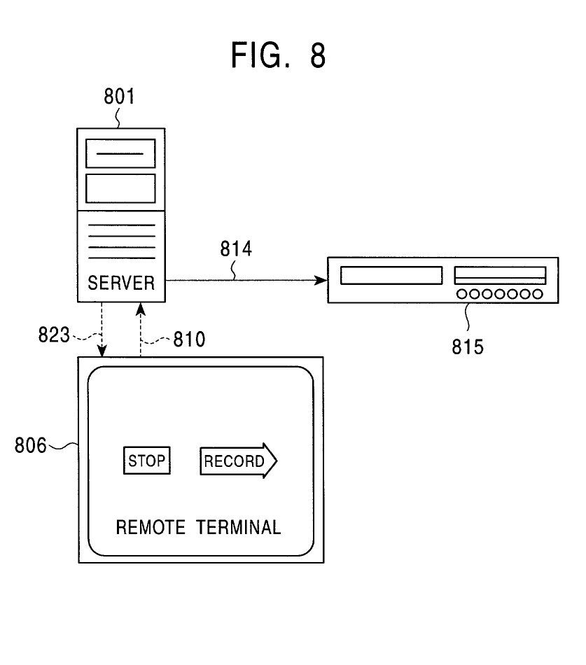

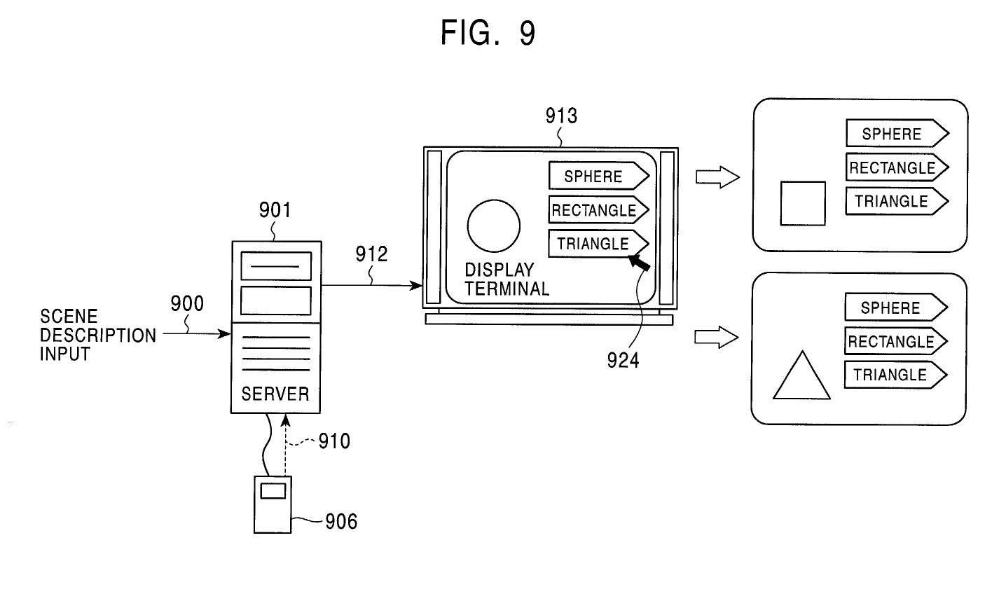

FIG. 2 illustrates an example of a user interface system enabling interaction contained in the contents itself and equipment control menu screens to be handled integrally, according to the first embodiment. The menu displayed on the remote terminal for equipment control is common with that shown in FIG. 8, and the example of the scene description input to the server 201 is common with that shown in FIG. 9. Scene description input containing interaction from the server 201 and scene description input for the equipment control menu are transmitted to the remote terminal 206 according to the present embodiment. At the remote terminal the sets of scene description are decoded and displayed. Accordingly, both decoded scenes of the contents itself containing interaction and the equipment control menu can be displayed at the remote terminal, and the user can perform operations at a single remote terminal without any difference between the two.

Though FIG. 2 shows both decoded scenes of the contents itself containing interaction and the equipment control menu displayed on the remote terminal simultaneously, an arrangement may be made wherein one is selected and displayed.

In the same way as the example in FIG. 8, once the user makes a selection of, for example, the record menu, on the remote terminal 206, user input information 210 to the effect that record has be selected is transmitted to the server 201, the server converts the user input information 210 into equipment control signals 214, and transmitting to the controlled equipment 215 (a VCR in the example in FIG. 2) starts the recording.

On the other hand, with the example in FIG. 9, in the event that the user selects, for example, the “rectangle” button contained beforehand in the scene description input on the remote terminal 206, user input information 210 to that effect is transmitted to the server 201, and the server 201 decodes the scene description input 200 based on the user input information, thereby displaying the decoded scene 212 for displaying the rectangular object on the display terminal 213.

The user can perform user input while viewing only the remote terminal 206, without ever looking at the display terminal 213, and also can perform operations at a common remote terminal without distinguishing between interactions contained in the scene description input and equipment control menus.

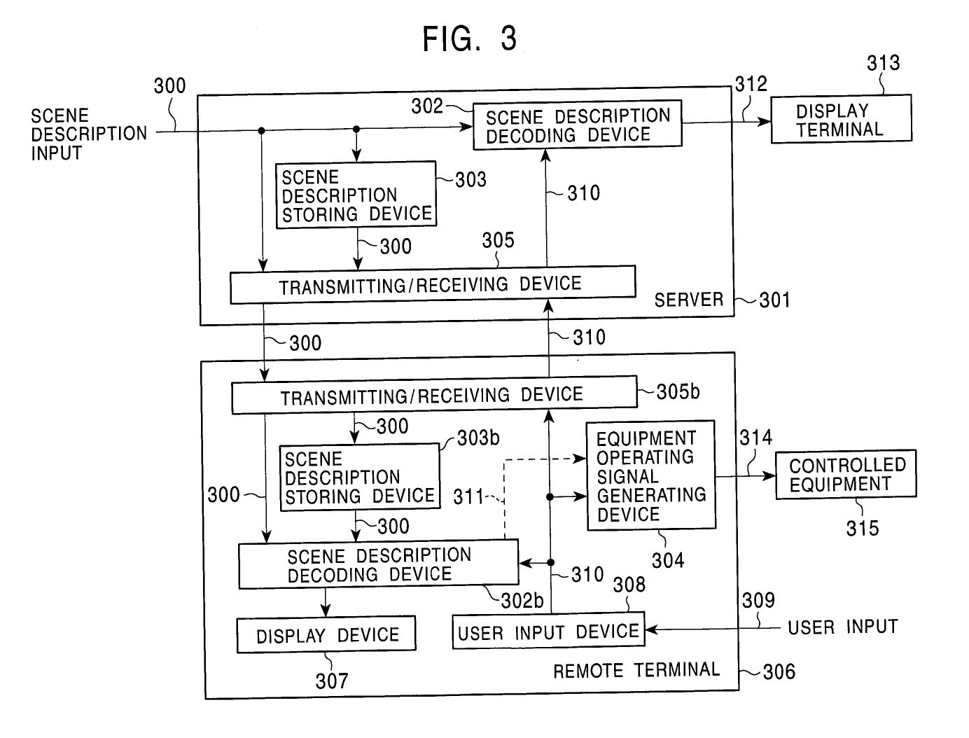

Description will be made regarding the user interface system according to the second embodiment of the present invention, with reference to FIG. 3.

This user interface system comprises a server 301 into which scene description 300, i.e., scene description information is input, a remote terminal 306 which displays the scene description 300 sent from the server 301 and receives user input 309 according to this display, a display terminal 313 for displaying decoded scenes 312 sent from the server 301, and controlled equipment 315 which is controlled by equipment controlling signals 314 sent from the remote terminal 306.

The server 301 has a scene description decoding device 302 for decoding decoded scenes 312 based on input scene description 300 and user input information 310, a scene description storing device 303 for storing input scene description 300, and a transmitting/receiving device 305 for sending scene description 300 either input or stored in the scene description storing device 303 to the remote terminal 306 and also receiving user input information 310 from the remote terminal 306 and sending this to the scene description decoding device 302.

The remote terminal 306 has a display device 307 for displaying decoded scenes 312, a user input device 308 for receiving user input 309 according to this display, a scene description decoding device 302b for decoding scene description 300 into decoded scenes 312 based on the user input information 310 from the user input device 308 and generating equipment control information 311, an equipment operating signal generating device 304 for generating equipment control signals 314 based on the user input information 310 from the user input device 308 and the equipment control information 311 from the scene description decoding device 302b, a scene description storing device 303b for storing scene description 300 and sending it to the scene description decoding device 302b, and a transmitting/receiving device 305b for receiving scene description 300 sent from the server 301 and sending it to the scene description decoding device 302b and scene description storing device 303b and also receiving user input information 310 from the user input device 308 and sending this to the server 301.

The difference between this and the configuration of the user interface system corresponding to the first embodiment shown in FIG. 1 is that the equipment operating signal generating device 304 is provided in the remote terminal 306, not the server 301. As with the first embodiment, the results of the operations made by the user viewing the decoded scene representing a menu for equipment control displayed on the remote terminal 306 are converted into equipment control signals 314 by the equipment operating signal generating device 304 in the remote terminal 306, which are sent to controlled equipment 315 by a transmitting device not shown in the drawings, without going through the server 301. Unlike the first embodiment, there is no need to send the equipment control signals 314 from the server 301 to the controlled equipment 315, which is advantageous in that connection between the server 301 and the controlled equipment 315 becomes unnecessary. Also, in the event that there is no need to decode contents made up of scene description containing interaction, there is no need to transmit the user input information 310 from the remote terminal 306 to the server, so the transmitting/receiving device 305 of the server 301 does not have to have receiving functions. In other words, a transmitting device for transmitting scene description for the equipment control menu is sufficient. Further, the a receiver device without transmitting functions is sufficient for the transmitting/receiving device 305b of the remote terminal 306.

In the event that the correlated relation of the equipment control information according to the user input information 310 is described in the scene description, the user input information 310 is mapped to the equipment control information 311 by the scene description decoding device 302b and then sent to the equipment control signal generating device 304. The present embodiment is also effective in cases wherein the controlled equipment 315 is the server 301 or remote terminal 306 itself.

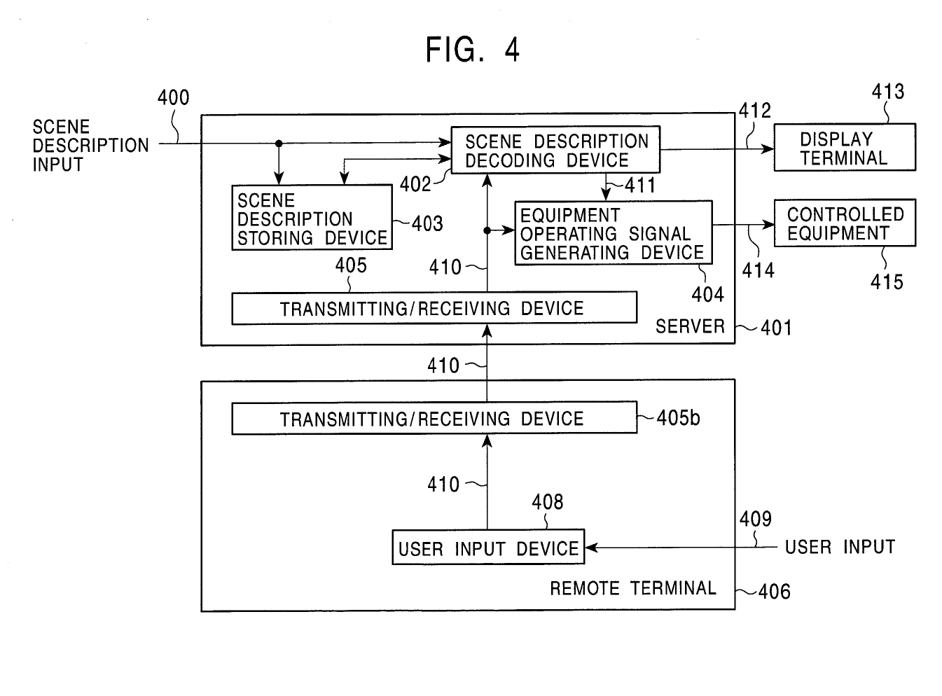

Description will be made regarding the user interface system according to the third embodiment of the present invention, with reference to FIG. 4.

This user interface system comprises a server 401 into which scene description 400, i.e., scene description information is input, a remote terminal 406 which and receives user input 409, a display terminal 413 for displaying decoded scenes 412 sent from the server 401, and controlled equipment 415 which is controlled by equipment controlling signals 414 sent from the server 401.

The server 401 has a scene description decoding device 402 for decoding decoded scenes 412 based on input scene description 400 and user input information 410 and for generating equipment control information 411, an equipment operating signal generating device 404 for generating equipment control signals based on the equipment control information 411 from the user inter information 410 and scene description decoding device 402, and a transmitting/receiving device 405 for sending user input information 410 sent from the remote terminal 406 to the scene description decoding device 402 and equipment operating signal generating device 404.

The remote terminal 406 has a user input device 408 for receiving user input 409, and a transmitting/receiving device 405b for transmitting user input information 410 from the user input device 408 to the server 401.

The difference between this and the configuration of the user interface system corresponding to the first embodiment shown in FIG. 1 is that this embodiment does not perform decoding or display of scene description at the remote terminal 406. The scene description decoding device 402 decodes menus for equipment control in addition to scene description such as digital TV broadcasts and DVD, Internet homepages, MPEG-4 BIFS, VRML, etc., and makes display thereof as decoded scenes 412 on the display terminal 413. Accordingly, the user can perform operations at a single remote terminal without any difference between the interaction contained in the scene description input and menus for equipment control, while watching the display terminal 413.

Note than the display terminal 412 and the remote terminal 406 can be integrated by using a display terminal having a user input device such as a touch panel.

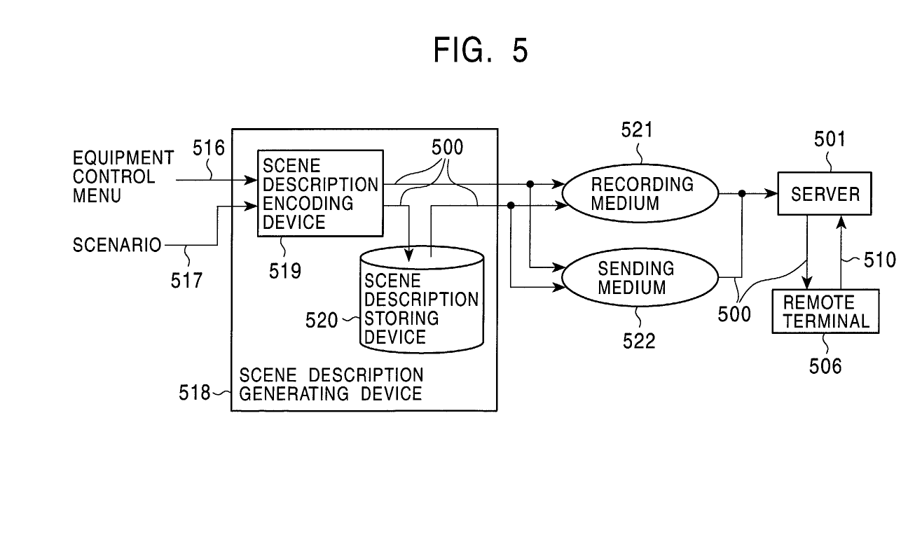

Description will be made regarding the configuration of the scene description generating device corresponding to the fourth embodiment of the present invention, with reference to FIG. 5.

The scene description generating device 518 has a scene description encoding device 519 for performing encoding to scene description 500 based on the input equipment control menu 516 and scenario 517, and a scene description storing device 520 for storing the scene description 500 from the scene description encoding device 519.

The server 501 receives the scene description 500 output from the scene description encoding device 519 of the scene description generating device and the scene description storing device 520, via the recording medium 521 or sending medium 522. The server 501 transmits and receives user input information 510 with the remote terminal 506.

The fourth embodiment relates to a device for generating scene description of contents such as digital TV broadcasts and DVD, Internet homepages, MPEG-4 BIFS, VRML, etc., and a device for generating scene descriptions representing menus for equipment control.

The scene description generating device 518 generates scene description which is the input of the servers in the first, second, and third embodiments. The server 501 and remote terminal 506 are the remote terminals of the servers in the first, second, and third embodiments. The scene description generating device 518 comprises a scene description encoding device 519. The scene description encoding device 519 according to the present embodiment takes scenario 517 for contents containing user interaction as the input thereof, and outputs scene description such as DVD, HTML, MPEG-4 BIFS, VRML, and so forth. Also, the equipment control menu 516 is used as input, and scene description representing a menu for equipment control is generated.

The server 501 and remote terminal 506 according to the present embodiment are capable of decoding scene description representing menus for equipment control with the scene description decoding device which decodes scene description of contents such as digital TV broadcasts and DVD, Internet homepages, MPEG-4 BIFS, VRML, and so forth, so the scene description encoding device 519 can generate scene description with both scene descriptions mixed.

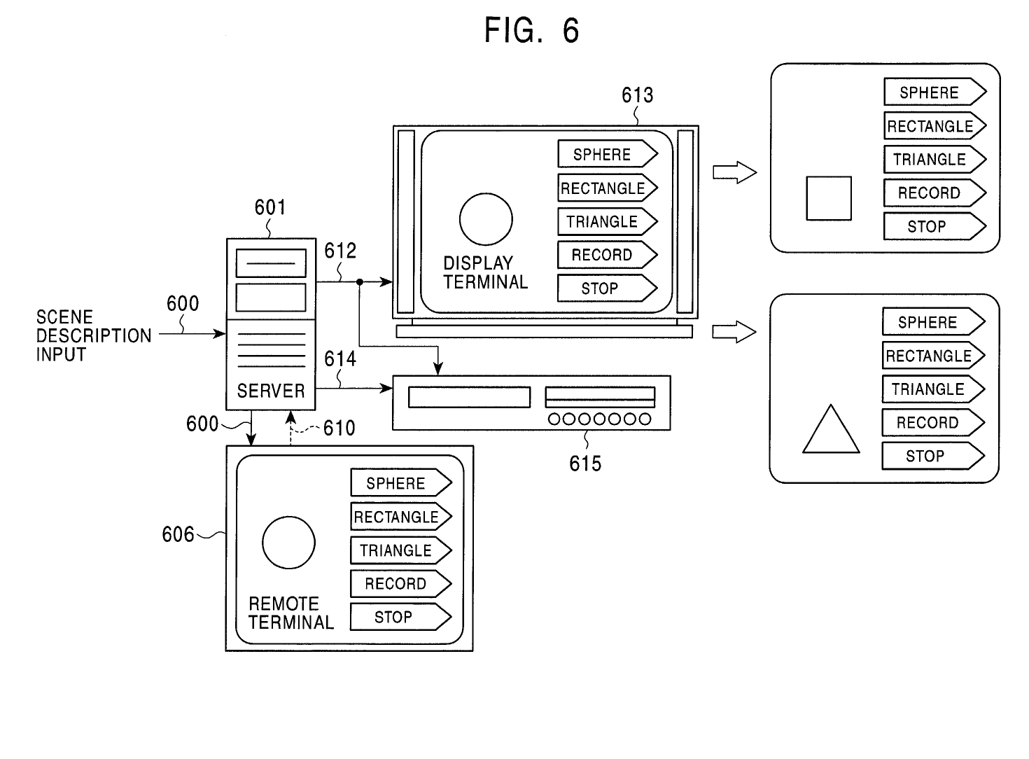

FIG. 6 shows an example of decoding and displaying scene description of contents containing interaction and scene description representing equipment control menus, in a mixed manner. For the sake of description, an example of scene description containing the same contents as those of FIG. 2 is shown. As with the example in FIG. 2, buttons for selecting a “sphere”, “rectangle”, and “triangle” are contained in the scene description, and in the event that the user selects the “rectangle” for example, a scene containing a rectangle is displayed. With the present embodiment, scene description of contents and scene description representing menus for equipment control can be mixed together, and FIG. 6 shows an example of a menu for causing the controlled equipment 615 (VCR) to perform recording, which is provided with an interface the same as that of the interaction contained in the contents.

The characteristics of the present invention wherein the scene description of contents containing interaction and scene description representing equipment control menus can be mixed enables a user interface with no differentiation between the two to be provided.

The scene description generated at the scene description encoding device 519 of the scene description generating device 518 shown in FIG. 5 or the scene description 500 temporarily accumulated in the scene description storing device 520 is sent to the server 501 by the recording medium 521 or sending medium 522. With the present embodiment, scene description representing menus for equipment control can be handled in the same manner as scene description of contents containing interaction, thereby enabling sharing of the recording medium for recording scene description of the contents and the sending medium for sending scene description of the contents.

Also, new equipment control menus can be updated by distributing scene description representing equipment control menus via the recording medium 521 or sending medium 522, and storing the menus to the scene description storing device within the server 501 (the scene description storing device 103 in FIG. 1, scene description storing device 303 in FIG. 3, scene description storing device 403 in FIG. 4) or the scene description storing device within the remote terminal 506 (the scene description storing device 103b in FIG. 1, scene description storing device 303b in FIG. 3). According to the present embodiment, recording mediums and sending mediums conventionally used of scene description of contents containing interaction can be used without any change for the recording medium and sending medium for updating the scene description for equipment control menus.

As described above, the present embodiment provides user input and equipment control regarding scenes containing interaction wherein input from users is received, such as still image signals, motion image signals, audio signals, text data, graphics data, etc. This art is suitably applied to, for example, performing user input at the remote terminal, interacting with scenes, controlling equipment, etc., at the time of playing from recording media such as magneto-optical disks or magnetic tape and displaying on a display or receiving contents of Internet broadcasts.

The present embodiment is a user interface system wherein scene description and menu scene description for equipment control is decoded and displayed at the remote terminal, at the time of viewing and listening to contents made up of scene description containing interaction from user input, such as digital TV broadcasts and DVD, HTML, MPEG-4 BIFS, VRML, and so forth, enabling the user interface for equipment control and the user interface for interaction contained in the scene description itself to be handled integrally.

Conventionally, in the event of viewing and listening to contents containing interaction from user input, such as digital TV broadcasts and DVD, Internet homepages, MPEG-4 BIFS, VRML, and so forth, the user had to operate the remote terminal while watching the display terminal.

With the present invention, the remote terminal comprises a scene description decoding device capable of decoding the same scene description as the server, and scene description is also distributed to and displayed the remote terminal, thereby allowing the user to perform user input regarding scenes containing user input interaction, while watching only the remote terminal.

Also, with the user interface system for transmitting menu data from the server to the remote terminal, at the time of performing equipment control with the remote terminal, the menu data for the remote terminal is of a data format dependent on the display device of the remote terminal, and accordingly there has been the problem that there is no compatibility in menu data between different remote terminals.

The present invention enables the user interface for equipment control and the user interface for interaction contained in the scene description itself to be handled integrally, by using scene description which can be decoded by the said scene description decoding device for the equipment control menu data, as well. The user can perform operations of the user interface for equipment control and interaction contained in the scene description itself, at a single remote terminal.

Further, the contents containing interaction and scene description representing the equipment control menu can be generated with the same scene description generating device, thereby enabling recording to the same recording medium and sending with the same sending medium, which is advantageous in that updating of the equipment control menu can be performed using a recording medium or sending medium for scene description of contents containing interaction.

What is claimed is:

1. A user interface system using scene description information containing user interaction, said system comprising:
a server; and
a remote terminal comprising
decoding means for decoding scene description information,
display means for displaying scenes, and
input means for inputting user input information;
wherein said server sends scene description information to said remote terminal, said remote terminal decodes scene description information sent from said server with the decoding means thereof and displays on said display means, and user input information input to said input means according to the display is sent to said server.

2. A user interface system according to claim 1, said server further comprising storing means for storing scene description information, wherein scene description information stored in said storing means is sent to said remote terminal.

3. A user interface system according to claim 2, said server further comprising equipment operating signal generating means for generating equipment control signals for controlling said server or external controlled equipment, wherein scene description information representing a menu for controlling equipment stored in said storing means is sent to said remote terminal, said remote terminal decodes the scene description information with the decoding means thereof and displays the menu for controlling equipment on the display means thereof, user input information input to said input means according to said display is sent to said server, and said server generates equipment control signals at the equipment operating signal generating means thereof based on the user input information.

4. A user interface system according to claim 2, said remote terminal further comprising equipment operating signal generating means for generating equipment control signals for controlling said remote terminal or external controlled equipment, wherein said server sends scene description information representing a menu for controlling equipment stored in said storing means to said remote terminal, said remote terminal decodes the scene description information with the decoding means thereof and displays the menu for controlling equipment on the display means thereof, and equipment control signals are generated at the equipment operating signal generating means thereof based on the user input information input to said input means based on the display.

5. A user interface system according to claim 1, said server further comprising:
decoding means for decoding scene description information; and
display means for displaying scene description information decoded by said decoding means;
wherein said decoding means decode scene description information of contents containing user interaction and scene description information representing an equipment control menu for controlling said server or external controlled device, and said display means display contents containing user interaction and said controlled equipment menu, thereby enabling operating of user interaction contained in scene description information and said equipment control menu upon said remote terminal without differentiation.

6. A user interface system according to claim 1, said server further comprising scene description generating means for generating scene description information, wherein scene description information generated by said scene description generating means is input.

7. A user interface system according to claim 6, wherein said scene description generating means generate scene description information for the equipment control menu for controlling said server or external controlled equipment, with the same scene description method as that of the contents.

8. A scene description generating device for generating scene description information containing user interaction, said device comprising generating means generating control scene description information for controlling external controlled equipment, with the same scene description method as that of the contents.

9. A scene description generating device according to claim 8, wherein said generating means generate scene description information containing, in a mixed manner, scene description information of contents containing user interaction and scene description information of a control menu for controlling external controlled equipment.

10. A scene description generating method for generating scene description information containing user interaction, said method comprising a generating step for generating control scene description information for controlling external controlled equipment, with the same scene description method as that of the contents.

11. A scene description generating method according to claim 10, wherein said generating step generates scene description information containing, in a mixed manner, scene description information of contents containing user interaction and scene description information of a control menu for controlling external controlled equipment.

12. A scene description distribution method using scene description information containing user interaction to distribute scene description information to a system comprising a server and remote terminal;
wherein scene description information of the device control menu generated by the same scene description method as that of the contents is distributed, and scene description information stored in said server or said remote terminal is updated with said scene description information.

13. A scene description distribution method according to claim 12, wherein scene description information containing in a mixed manner scene description information of contents containing user interaction and scene description information of an equipment control menu is distributed, and scene description information stored in said server or said remote terminal is updated with said scene description information.

14. A server device which uses scene description information containing user interaction and cooperatively with a remote terminal configures a user interface, wherein scene description information is sent to said remote terminal, and user input information input according to said scene description information which has been decoded and display at said remote terminal is received.

15. A server device according to claim 14, comprising storing means for storing scene description information, wherein scene description information stored in said storing means is sent to said remote terminal.

16. A server device according to claim 15, comprising equipment operating signal generating means for generating equipment control signals for controlling external controlled devices, wherein scene description information representing a menu for controlling equipment is stored in said storing means, said scene description information is sent to said remote terminal, and user input information input according to said scene description decoded and displayed at said remote terminal is received.

17. A server device according to claim 15, wherein scene description information representing a device control menu is stored in said storing means, said scene description information is sent to said remote terminal, and equipment control signals for controlling external controlled devices are generated at said remote terminal based on user input information input according to said scene description information that has been decoded and displayed.

18. A server device according to claim 14, further comprising:
decoding means for decoding scene description information; and
display means for displaying scene description information decoded by said decoding means;
wherein said decoding means decode scene description information containing user interaction and scene description information representing a control menu for controlling external controlled device, and said display means display scenes for contents containing user interaction and scenes for said control menu, thereby enabling operating of user interaction contained in scene description information and said control menu at said remote terminal without differentiation.

19. A server device according to claim 14, further comprising scene description generating means for generating scene description information, wherein scene description information generated by said scene description generating means is taken as input.

20. A server device according to claim 19, wherein said scene description generating means generate scene description information for the equipment control menu for controlling external controlled equipment, with the same scene description method as that of the contents.

21. A remote terminal device which uses scene description information containing user interaction and cooperatively with a server configures a user interface, said device comprising:
decoding means for decoding scene description information;
display means for displaying scenes; and
input means for inputting user input information;
scene description information sent from said server is decoded and displayed on said display means, and user input information input to said input means according to the display is sent to said server.

22. A remote terminal device according to claim 21, wherein scenes representing a menu for controlling equipment sent from said server is received, the received scene description information is decoded with said decoding means and displayed on said display means, user input information input to said input means according to said display is sent to said server, and said server generates equipment control signals for controlling external controlled devices based on the user input information.

23. A sending medium for sending scene description information containing user interaction, wherein said scene description information describing the equipment control menu is described with the same scene description method as that of the contents.

24. A sending medium according to claim 23, wherein said scene description information comprises scene description information of contents containing user interaction and scene description information of an equipment control menu, in a mixed manner.

25. A recording medium for recording scene description information containing user interaction, wherein said scene description information describing the equipment control menu is recorded with the same scene describing method as that of the contents.

26. A recording medium according to claim 25, wherein said scene description information comprises scene description information of contents containing user interaction and scene description information of an equipment control menu, in a mixed manner.
